(19) United States
(12) Patent Application Publication
(10) Pub. No.: US 2026/0307102 A1
(43) Pub. Date: Oct. 8, 2026

(54) PAINT COVER APPARATUS

(71) Applicant: Marlene Jackson, East Saint Louis, IL (US)

(72) Inventor: Marlene Jackson, East Saint Louis, IL (US)

(21) Appl. No.: 19/171,661

(22) Filed: Apr. 7, 2025

(51) Int. Cl. B05D 1/32

(52) U.S. Cl. CPC B05D 1/322

(57) ABSTRACT

The disclosure provides for a paint cover apparatus that includes a sheet designed to define a cavity and three openings. The three openings are a first opening that forms a neck, a second opening that forms a base, and a third opening that extends between the first and second openings. The third opening is oriented substantially perpendicular to the first and second openings, while the first and second openings are substantially parallel to each other. Furthermore, the third opening connects the first and second openings, and the cavity defined by the sheet is flexible and/or paint-resistant.

### CROSS-REFERENCE TO RELATED APPLICATIONS

This application does not claim the benefit of any prior filed U.S. or foreign patent application.

### FEDERALLY SPONSORED RESEARCH AND DEVELOPMENT

Not applicable.

### FIELD OF THE DISCLOSURE

The present disclosure relates to an apparatus, method, and system for safeguarding ceilings, walls, and other surfaces from paint through a specialized paint cover.

### BACKGROUND OF THE INVENTION

A paint cover offers several benefits that people can use during painting jobs to avoid spills, drips, splatters, and other mishaps. A painting job can stain and damage multiple surfaces, including furniture, light fixtures, kitchen appliances, bathroom fixtures, doors, and windows. A paint cover can protect these surfaces and prevent unintentional spills, drips, or splatters.

Unprotected surfaces during painting projects often require significant post-painting cleanup. Once paint dries on unintended surfaces, removal may involve labor-intensive methods such as scraping or sanding, which can result in permanent damage. Porous materials and fabrics are especially prone to irreversible staining due to their rapid absorption of paint. Preventative covering of such surfaces reduces cleanup time, preserves material integrity, and prevents costly damage.

The present disclosure provides a protective apparatus that facilitates a more efficient, cleaner, and damage-free painting process by shielding surfaces from unintended paint exposure.

### SUMMARY OF THE INVENTION

This application relates to an apparatus, system, and method for safeguarding ceilings, walls, and other surfaces from paint through a new and unique specialized paint cover.

The disclosure also provides support for a paint cover apparatus comprising: a sheet configured to define a cavity, three openings, wherein the three openings comprise: a first opening configured to form a neck, a second opening configured to form a base, and a third opening extending between the first and second openings, the third opening being oriented perpendicular to the first and second openings, wherein the first and second openings are substantially parallel to each other, wherein the third opening is configured to connect the first and second openings, and wherein the cavity defined by the sheet is flexible and paint-resistant.

The paint cover of this disclosure is referred to as a cover and comprises flexible materials with at least two openings: a first opening at the top of the cover and a second opening at the bottom of the cover. One or both openings may further comprise a stretchable and/or elastic material, along with drawstrings, configured to increase or decrease the opening size/s.

The techniques described herein relate to a paint cover apparatus including a sheet and three openings: a first smaller opening, referred to as a neck, a second larger opening, referred to as a base, and a third perpendicular opening, wherein the first and the second openings are parallel to each other, wherein the third opening is perpendicular to the first and second opening, wherein the third opening is configured to join the first and second openings, wherein the apparatus is configured to include of a cavity and wherein the cavity is flexible and paint-resistant.

In some aspects of the techniques described herein, the flexible may have one or more zippers running from top to bottom, side to side, or both.

In some aspects, the techniques described herein relate to an apparatus that may be reusable.

In some aspects, the techniques described herein relate to an apparatus that may include at least one attachment system.

In some aspects, the techniques described herein relate to an apparatus that may include at least one elastic system.

In some aspects, the techniques described herein relate to an apparatus, wherein the neck's size is from 6 inches to 75 inches when open.

In some aspects, the techniques described herein relate to an apparatus, wherein the neck is from 0 to 71 inches when closed.

In some aspects, the techniques described herein relate to an apparatus, wherein the neck is rubberized, wherein the rubberized includes one or more selected from a group consisting of high-density spun bound polyethylene fibers, spun bond Polypropylene, silicone, neoprene, polyurethane, ethylene propylene diene monomer, nitrile rubber, polyvinyl chloride, thermoplastic elastomers, natural rubber latex, thermoplastic polyester elastomer, butyl rubber, cork, fluor elastomer, styrene-butadiene rubber, graphene-enhanced materials, natural rubber, man-made rubber, polymer, flex seal, and any combination thereof.

In some aspects, the techniques described herein relate to an apparatus, wherein the neck including of one or more selected from a group consisting of high-density spun bound polyethylene fibers, spun bond Polypropylene, Melt blown Polypropylene, Polyethylene-Coated Fabrics, Polyvinyl Chloride Coated Fabrics, Woven High-Density Polyethylene Fabrics, High-Density Polyethylene Geomembranes, waxed fabric or paper, Mylar, biaxially-oriented polyethylene terephthalate, Polyester Film, Non-Woven Cellulose Materials, Vellum, Yupo synthetic paper, Gore-Tex, expanded polytetrafluoroethylene, Polylactic Acid Non-Woven Fabrics, Eco-Non-Woven Fabrics made from natural fibers like jute or hemp, PE or PVC-Coated Tarpaulins, and any combination thereof.

In some aspects, the techniques described herein relate to an apparatus, wherein the base includes at least one elastic system, specifically one or more drawstrings, which are located at the bottom of the base.

In some aspects, the techniques described herein relate to an apparatus, wherein the apparatus includes at least one drawstring, wherein the drawstrings include one or more selected from cotton, nylon, polyester, leather, Paracord, jute, hemp, Elastic Cords, Polypropylene, silk, satin, blended fibers, natural and synthetic fibers, and any combination thereof.

In some aspects, the techniques described herein relate to an apparatus, wherein the base's size is 6 inches to 75 inches when in the open state.

In some aspects, the techniques described herein relate to an apparatus, wherein the base's size is 0 to 70 inches in the closed state.

In some aspects, the techniques described herein relate to an apparatus, where the sheet is up to 2500 inches in diameter.

In some aspects, the techniques described herein relate to an apparatus, wherein the third opening includes two sides, a left side and a right side, wherein one or both sides include an attachment system, and wherein the attachable system is detachably attached.

In some aspects, the techniques described herein relate to an apparatus, wherein the attachment system includes a group consisting of a zipper, hook-and-loop fasteners, Velcro, buttons, snaps and buttons, buttons-holes, stapling, pinning, riveting, snaps, fabric snaps, binding, taping, safety-pins, hand-basting stitches, machine-basting stitches, stapling, magnets, stapling magnets, magnetic fasteners, fabric tape, removal tape, adhesive tapes, glue, adhesives, double-sides taps, mechanical fasteners, plastic clamps, hook and eye, suction cups, and any combination thereof.

In some aspects, the techniques described herein relate to an apparatus, wherein the perpendicular opening's size is from 1 inch to 1200 inches.

In some aspects, the techniques described herein relate to an apparatus, wherein the sheet includes of textile, wherein textile is selected from a group consisting of plant natural fibers, cotton, flax, linen, animals natural fibers, wool, silk, minerals natural fibers, asbestos, synthetic fibers, polyester, nylon, petrochemicals nylon, petrochemicals acrylic, polyacrylonitrile-acrylic polyester from polyethylene terephthalate, recycled plastic, and any combination thereof.

In some aspects, the techniques described herein relate to an apparatus, wherein the sheet is coated with waterproof materials selected from a group consisting of polyurethane, polyvinyl chloride, polytetrafluoroethylene, and any combination thereof.

In some aspects, the techniques described herein relate to an apparatus, wherein the sheet is coated with water-resistant materials selected from a group consisting of durable water-repellent coating, hydrophobic fibers, synthetic fibers, polyester, nylon, naturally resistant to water absorption, and any combination thereof.

In some aspects, the techniques described herein relate to an apparatus wherein the cavity is configured to contain at least one item that protects against chemicals, water, moisture, and environmental temperature fluctuations.

### BRIEF DESCRIPTION OF DRAWINGS

FIG. 1. Top view of flattened apparatus.

FIG. 2. Side view of the apparatus. T

FIG. 2A. The neck features are further shown in detail.

FIG. 2B. The base features are shown in detail.

FIG. 3. Side view of the apparatus with a ceiling fan inside without the base closing.

FIG. 4. Views of the apparatus with items within the apparatus cavity.

FIG. 4A. View of the apparatus with a refrigerator within the apparatus cavity.

FIG. 4B. View of the apparatus with a chair within the apparatus cavity.

FIG. 4C. View of the apparatus with a door within the apparatus cavity.

FIG. 4D. View of the apparatus with a tree within the apparatus cavity.

FIG. 4E. View of the apparatus with a sofa within the apparatus cavity.

### DETAILED DESCRIPTION OF THE INVENTION

Examples of embodiments are provided so that this disclosure will be thorough and fully convey the scope to those skilled in the art. Numerous specific details are set forth, such as examples of specific components, devices, and methods, to provide a thorough understanding of the embodiments of the present disclosure. It will be apparent to those skilled in the art that specific details need not be employed, that example embodiments may be embodied in many different forms, and that neither should be construed to limit the scope of the disclosure. In some examples, embodiments, aspects, well-known processes, well-known device structures, and well-known technologies are not described in detail least one specification heading is required.

The terminology used herein is for the purpose of describing particular example embodiments only and is not intended to be limiting. As used herein, the singular forms “a,” “an,” and “the” may be intended to include the plural forms as well unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

All measurements are in inches unless otherwise stated.

The techniques described herein relate to a paint cover apparatus including a flexible, paint-resistant, chemical-resistant, and water-resistant sheet, wherein the apparatus includes three openings: a first smaller opening, referred to herein as a neck, a second larger opening referred to herein as a base, and a third perpendicular/vertical opening. The first and the second openings are parallel to each other. Conversely, the third opening is perpendicular/vertical to the first and second openings and configured to join the first and second openings. When one, two, and/or three openings are fully or partially closed, the sheet forms a cavity with the neck at the top end, the base at the bottom end of the cavity, and the perpendicular/vertical on the side running from top to bottom.

The cavity may hold items within that need to be protected from one or more paints, chemicals (liquid, solid, and/or gas), environmental elements, such as water, moisture, dust, rain, snow, temperature, etc., and/or any combination thereof.

In some aspects, the techniques described herein relate to the cavity that may be 100% open when all three openings (neck, base, and perpendicular/vertical) may be completely open/100% open/0% closed. However, when one opening is 100% open/0% closed (and the other two are completely closed/100% closed), the cavity is 33% open; when two openings are completely (100%) open, the cavity is 66% open. The cavity may be partially or fully enclosed depending on the configuration of the openings.

In some aspects, the techniques described herein relate to the apparatus as a whole or part thereof, such as the sheet, first, second, third, base, etc., may form a conical, triangular, circular, square, rectangular, pentagon, heptagon, octagon, nonagon, pleated, etc., and/or any combination thereof.

In some aspects, the techniques described herein relate to at least one elastic system per one, two, and/or three openings. The elastic system may assist in opening-closing one, two, and/or three openings. It may assist in the flexibility and stretchability of the cavity when integrated with the sheet with or without one, two, and/or three openings.

In some aspects, the techniques described herein relate to the neck, base, perpendicular/vertical opening, and/or sheet that may be stretchable and/or elastic materials by using stretchable, elastic materials, waffling, drawstring, etc., and/or any combination thereof.

In some aspects, the techniques described herein relate to the elastic system of one, two, and/or three opening/s and/or the sheet may be ruche, shirred, puckered, pleated, smocked, cinched, bunched, ruffled, tucked, draped, etc., and any combination thereof. This may add to the elastic, stretchable nature of these openings. This may be made with a drawstring, strap, belts, cord locks, ties, ribbons, elastic bands, etc., and/or any combination thereof.

In some aspects, the techniques described herein relate to the neck, which may be stretchable and/or elastic (elastic system) using stretchable, elastic materials, waffling, drawstring, etc., and/or any combination thereof. The stretch/elasticity for the neck may be from 0 inches (completely/100% closed) up to 300 inches (completely/100% open), making 100% stretch.

In some aspects, the techniques described herein relate to the neck size may be from 1 inch to 300 inches when in completely open form. When the base is semi-circular, the measurement is in diameter; otherwise, it is long. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 2010, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, etc., and/or any combination thereof.

In some aspects, the techniques described herein relate to the neck that is closed from 0 to 300 inches when closed, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 2010, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, etc., and/or any combination thereof.

In some aspects, the techniques described herein relate to the neck may be rubberized, wherein the rubberized may by making the neck, a part of the neck, and/or coating the neck with one or more selected from a group comprising of silicone, neoprene, polyurethane, ethylene propylene diene monomer, nitrile rubber, polyvinyl chloride, thermoplastic elastomers, natural rubber latex, thermoplastic polyester elastomer, butyl rubber, cork, fluor elastomer, styrene-butadiene rubber, graphene-enhanced materials, natural rubber, man-made rubber, polymer, flex seal, and/or any combination thereof.

In some aspects, the techniques described herein relate to the neck, or part of the neck may be comprised of one or more from a selected group comprising of tyrek, high-density spun bound polyethylene fibers, spunbonded polypropylene, melt blown polypropylene, polyethylene-coated fabrics, polyvinyl chloride coated fabrics, woven high-density polyethylene fabrics, high-density polyethylene geomembranes, waxed fabric or paper, mylar, biaxially-oriented polyethylene terephthalate, polyester film, non-woven cellulose materials, vellum, Yupo synthetic paper, Gore-tex, expanded polytetrafluoroethylene, polylactic acid non-woven fabrics, eco-non-woven fabrics made from natural fibers like jute or hemp, PE or PVC-coated tarpaulins, and/or any combination thereof.

In some aspects, the techniques described herein relate to the neck that may have at least one drawstring, for example, 1, 2, 3, 4, 5, 6, 7, 8, 9, 10, etc., and any combination thereof. The drawstrings may be located at the neck bottom, middle, top, and/or anywhere between the top and bottom. The drawstring may be configured to make the neck opening smaller, close, near close, and/or any combination thereof. The drawstrings may be made of cotton, nylon, polyester, leather, Paracord, jute, hemp, Elastic Cords, Polypropylene, silk, satin, blended fibers, natural and synthetic fibers, and/or any combination thereof.

In some aspects, the techniques described herein relate to the base, which may be stretchable and/or elastic (elastic system) using stretchable, elastic materials, waffling, drawstring, etc., and/or any combination thereof. The stretch/elasticity for the base may be from 0 inches (completely/100% closed) up to 1000 inches (completely/100% open), making 100% stretch.

In some aspects, the techniques described herein relate to the base may be rubberized, wherein the rubberized may by making the base, a part of the base, and/or coating the base with one or more selected from a group comprising of silicone, neoprene, polyurethane, ethylene propylene diene monomer, nitrile rubber, polyvinyl chloride, thermoplastic elastomers, natural rubber latex, thermoplastic polyester elastomer, butyl rubber, cork, fluor elastomer, styrene-butadiene rubber, graphene-enhanced materials, natural rubber, man-made rubber, polymer, flex seal, and/or any combination thereof.

In some aspects, the techniques described herein relate to the base, or part of the base may be comprised of one or more from a selected group comprising of tyrek, high-density spun bound polyethylene fibers, spunbonded polypropylene, melt blown polypropylene, polyethylene-coated fabrics, polyvinyl chloride coated fabrics, woven high-density polyethylene fabrics, high-density polyethylene geomembranes, waxed fabric or paper, mylar, biaxially-oriented polyethylene terephthalate, polyester film, non-woven cellulose materials, vellum, Yupo synthetic paper, Gore-tex, expanded polytetrafluoroethylene, polylactic acid non-woven fabrics, eco-non-woven fabrics made from natural fibers like jute or hemp, PE or PVC-coated tarpaulins, and/or any combination thereof.

In some aspects, the techniques described herein relate to the base that may have at least one drawstrings, for example, 1, 2, 3, 4, 5, 6, 7, 8, 9, 10, etc., and any combination thereof. The drawstrings may be located at the base-bottom, top, and/or anywhere between the top and the bottom and may be configured to make the neck opening smaller, close, near close, and/or any combination thereof. The drawstrings may be made of cotton, nylon, polyester, leather, Paracord, jute, hemp, Elastic Cords, Polypropylene, silk, satin, blended fibers, natural and synthetic fibers, and/or any combination thereof.

In some aspects, the techniques described herein relate to the base size of 40 inches to 1000 inches when in the fully open state. When the base is semi-circular, the measurement is in diameter; otherwise, it is in length. For example, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 2010, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000, etc., and/or any combination thereof.

In some aspects, the techniques described herein relate to an apparatus wherein the base size is 0 to 950 inches when closed; when the base is semi-circular, the measurement is in diameter, otherwise in length. For example, 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 2010, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, etc., and/or any combination thereof.

In some aspects, the techniques described herein relate to at least one attachment system per one, two, three openings, and/or sheet. The attachment system may attach one or more parts of the apparatus together and/or attach to objects outside the apparatus, the cavity, and/or items within the cavity.

In some aspects, the techniques described herein relate to the attachment system may include one or more selected from a group of a zipper, hook-and-loop fasteners, Velcro, buttons, snaps and buttons, buttons-holes, stapling, pinning, riveting, snaps, fabric snaps, binding, taping, safety-pins, hand-basting stitches, machine-basting stitches, stapling, magnets, stapling magnets, magnetic fasteners, fabric tape, removal tape, adhesive tapes, glue, adhesives, double-sides taps, mechanical fasteners, plastic clamps, hook and eye, sucking cups, belts, strap, buckle, and/or any combination thereof.

In some aspects, the techniques described herein relate to the third perpendicular/vertical opening, which may have four sides: a top side connected to the neck and a bottom connected to the base, a left side, and a right side, 1, 2, 3, 4, and/or any combination of sides have an attachment system, and the attachable system may be detachably attached.

In some aspects, the techniques described herein relate to an apparatus, wherein the perpendicular/vertical opening size is 1 to 1500 inches. This measurement is in length. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 2010, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000, 1001, 1002, 1003, 1004, 1005, 1006, 1007, 1008, 1009, 1010, 1011, 1012, 1013, 1014, 1015, 1016, 1017, 1018, 1019, 1020, 1021, 1022, 1023, 1024, 1025, 1026, 1027, 1028, 1029, 1030, 1031, 1032, 1033, 1034, 1035, 1036, 1037, 1038, 1039, 1040, 1041, 1042, 1043, 1044, 1045, 1046, 1047, 1048, 1049, 1050, 1051, 1052, 1053, 1054, 1055, 1056, 1057, 1058, 1059, 1060, 1061, 1062, 1063, 1064, 1065, 1066, 1067, 1068, 1069, 1070, 1071, 1072, 1073, 1074, 1075, 1076, 1077, 1078, 1079, 1080, 1081, 1082, 1083, 1084, 1085, 1086, 1087, 1088, 1089, 1090, 1091, 1092, 1093, 1094, 1095, 1096, 1097, 1098, 1099, 1100, 1101, 1102, 1103, 1104, 1105, 1106, 1107, 1108, 1109, 1110, 1111, 1112, 1113, 1114, 1115, 1116, 1117, 1118, 1119, 1120, 1121, 1122, 1123, 1124, 1125, 1126, 1127, 1128, 1129, 1130, 1131, 1132, 1133, 1134, 1135, 1136, 1137, 1138, 1139, 1140, 1141, 1142, 1143, 1144, 1145, 1146, 1147, 1148, 1149, 1150, 1151, 1152, 1153, 1154, 1155, 1156, 1157, 1158, 1159, 1160, 1161, 1162, 1163, 1164, 1165, 1166, 1167, 1168, 1169, 1170, 1171, 1172, 1173, 1174, 1175, 1176, 1177, 1178, 1179, 1180, 1181, 1182, 1183, 1184, 1185, 1186, 1187, 1188, 1189, 1190, 1191, 1192, 1193, 1194, 1195, 1196, 1197, 1198, 1199, 1200, 1201, 1202, 1203, 1204, 1205, 1206, 1207, 1208, 1209, 1210, 1211, 1212, 1213, 1214, 1215, 1216, 1217, 1218, 1219, 1220, 1221, 1222, 1223, 1224, 1225, 1226, 1227, 1228, 1229, 1230, 1231, 1232, 1233, 1234, 1235, 1236, 1237, 1238, 1239, 1240, 1241, 1242, 1243, 1244, 1245, 1246, 1247, 1248, 1249, 1250, 1251, 1252, 1253, 1254, 1255, 1256, 1257, 1258, 1259, 1260, 1261, 1262, 1263, 1264, 1265, 1266, 1267, 1268, 1269, 1270, 1271, 1272, 1273, 1274, 1275, 1276, 1277, 1278, 1279, 1280, 1281, 1282, 1283, 1284, 1285, 1286, 1287, 1288, 1289, 1290, 1291, 1292, 1293, 1294, 1295, 1296, 1297, 1298, 1299, 1300, 1301, 1302, 1303, 1304, 1305, 1306, 1307, 1308, 1309, 1310, 1311, 1312, 1313, 1314, 1315, 1316, 1317, 1318, 1319, 1320, 1321, 1322, 1323, 1324, 1325, 1326, 1327, 1328, 1329, 1330, 1331, 1332, 1333, 1334, 1335, 1336, 1337, 1338, 1339, 1340, 1341, 1342, 1343, 1344, 1345, 1346, 1347, 1348, 1349, 1350, 1351, 1352, 1353, 1354, 1355, 1356, 1357, 1358, 1359, 1360, 1361, 1362, 1363, 1364, 1365, 1366, 1367, 1368, 1369, 1370, 1371, 1372, 1373, 1374, 1375, 1376, 1377, 1378, 1379, 1380, 1381, 1382, 1383, 1384, 1385, 1386, 1387, 1388, 1389, 1390, 1391, 1392, 1393, 1394, 1395, 1396, 1397, 1398, 1399, 1400, 1401, 1402, 1403, 1404, 1405, 1406, 1407, 1408, 1409, 1410, 1411, 1412, 1413, 1414, 1415, 1416, 1417, 1418, 1419, 1420, 1421, 1422, 1423, 1424, 1425, 1426, 1427, 1428, 1429, 1430, 1431, 1432, 1433, 1434, 1435, 1436, 1437, 1438, 1439, 1440, 1441, 1442, 1443, 1444, 1445, 1446, 1447, 1448, 1449, 1450, 1451, 1452, 1453, 1454, 1455, 1456, 1457, 1458, 1459, 1460, 1461, 1462, 1463, 1464, 1465, 1466, 1467, 1468, 1469, 1470, 1471, 1472, 1473, 1474, 1475, 1476, 1477, 1478, 1479, 1480, 1481, 1482, 1483, 1484, 1485, 1486, 1487, 1488, 1489, 1490, 1491, 1492, 1493, 1494, 1495, 1496, 1497, 1498, 1499, 1500, etc., and any combination thereof.

In some aspects, the techniques described herein relate to the neck, base, and/or perpendicular/vertical opening that may be made of textile.

In some aspects, the techniques described herein relate to the neck, base, and/or perpendicular/vertical opening that may be made of one or more selected from a group comprising of plant natural fibers (such as cotton, flax, linen), animals natural fibers (such as wool, silk), minerals natural fibers (for example, asbestos), synthetic fibers, polyester, nylon, petrochemicals nylon, petrochemicals acrylic, polyacrylonitrile-acrylic polyester from polyethylene terephthalate, recycled plastic, etc., and/or any combination thereof.

In some aspects, the techniques described herein relate to the neck, base, and/or perpendicular/vertical opening being coated with waterproof materials selected from a group comprising polyurethane (PU), polyvinyl chloride (PVC), polytetrafluoroethylene (PTFE), etc., and/or any combination thereof. This coating layer/s may form a barrier that prevents water from penetrating the sheet/textile while allowing vapor/air to escape in some cases, making the material breathable.

In some aspects, the techniques described herein relate to the neck, base, and/or perpendicular/vertical opening that may be made of fabrics that may be made with highly tight weaves, like ripstop nylon, which help reduce the spaces between fibers, making it harder for water to pass through. Combined with or without waterproof coatings, this may create a robust barrier.

In some aspects, the techniques described herein relate to the neck, base, and/or perpendicular/vertical opening that may be coated with durable water-resistant/repellent materials selected from a group comprising a Fluoropolymer-based DWR (PFCs), Perfluorocarbons (PFCs), fluorocarbons, silicone, wax, Polyurethane, Graphene, Cationic Hydrophobic Polymer, etc., and/or any combination thereof.

In some aspects, the techniques described herein relate to the neck, base, and/or perpendicular/vertical opening that may have a durable water-repellent coating, and the treated sheet surface may be the fabric, causing water to bead up and roll off the surface instead of being absorbed. This treatment may need to be reapplied when it wears off. Furthermore, one or more of the three openings and/or the sheet may be made of hydrophobic fibers, such as polyester and nylon, naturally resisting water absorption. Combined with the water-resistant/repellent coating, they become more effective at repelling moisture.

In some aspects, the techniques described herein relate to the attachment system, elastic system, neck, base, sheet, and/or perpendicular/vertical opening may be waterproof, water-resistant, air-tight, near air-tight, chemical-resistant, chemical-proof, breathable, anti-microbial, and/or any combination thereof.

In some aspects, the techniques described herein relate to the sheet may be rubberized, wherein the rubberized may be by making the sheet, a part of the sheet, and/or coating the sheet with one or more selected from a group comprising of silicone, neoprene, polyurethane, ethylene propylene diene monomer, nitrile rubber, polyvinyl chloride, thermoplastic elastomers, natural rubber latex, thermoplastic polyester elastomer, butyl rubber, cork, fluor elastomer, styrene-butadiene rubber, graphene-enhanced materials, natural rubber, man-made rubber, flex seal, polymer, and/or any combination thereof.

In some aspects, the techniques described herein relate to the sheet, or part of the sheet may be comprised of one or more from a selected group comprising of tyrek, high-density spun bound polyethylene fibers, spunbonded polypropylene, melt blown polypropylene, polyethylene-coated fabrics, polyvinyl chloride coated fabrics, woven high-density polyethylene fabrics, high-density polyethylene geomembranes, waxed fabric or paper, mylar, biaxially-oriented polyethylene terephthalate, polyester film, non-woven cellulose materials, vellum, Yupo synthetic paper, Gore-tex, expanded polytetrafluoroethylene, polylactic acid non-woven fabrics, eco-non-woven fabrics made from natural fibers like jute or hemp, PE or PVC-coated tarpaulins, polymers, flex seal and/or any combination thereof.

In some aspects, the techniques described herein relate to the sheet that may have at least one drawstring, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, etc., and any combination thereof. The drawstrings may be located at the sheet bottom, top, middle, and/or anywhere between the top and bottom. The drawstring/s may be configured to make the apparatus stretchable and flexible to fit item/s within the cavity. The drawstrings may be made of cotton, nylon, polyester, leather, Paracord, jute, hemp, Elastic Cords, Polypropylene, silk, satin, blended fibers, natural and synthetic fibers, and/or any combination thereof.

In some aspects, the techniques described herein relate to an apparatus, wherein the sheet size/diameter is up to 2500 inches. When the sheet is circular, the size is in diameter. Otherwise, the measure is in length. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 2010, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000, 1001, 1002, 1003, 1004, 1005, 1006, 1007, 1008, 1009, 1010, 1011, 1012, 1013, 1014, 1015, 1016, 1017, 1018, 1019, 1020, 1021, 1022, 1023, 1024, 1025, 1026, 1027, 1028, 1029, 1030, 1031, 1032, 1033, 1034, 1035, 1036, 1037, 1038, 1039, 1040, 1041, 1042, 1043, 1044, 1045, 1046, 1047, 1048, 1049, 1050, 1051, 1052, 1053, 1054, 1055, 1056, 1057, 1058, 1059, 1060, 1061, 1062, 1063, 1064, 1065, 1066, 1067, 1068, 1069, 1070, 1071, 1072, 1073, 1074, 1075, 1076, 1077, 1078, 1079, 1080, 1081, 1082, 1083, 1084, 1085, 1086, 1087, 1088, 1089, 1090, 1091, 1092, 1093, 1094, 1095, 1096, 1097, 1098, 1099, 1100, 1101, 1102, 1103, 1104, 1105, 1106, 1107, 1108, 1109, 1110, 1111, 1112, 1113, 1114, 1115, 1116, 1117, 1118, 1119, 1120, 1121, 1122, 1123, 1124, 1125, 1126, 1127, 1128, 1129, 1130, 1131, 1132, 1133, 1134, 1135, 1136, 1137, 1138, 1139, 1140, 1141, 1142, 1143, 1144, 1145, 1146, 1147, 1148, 1149, 1150, 1151, 1152, 1153, 1154, 1155, 1156, 1157, 1158, 1159, 1160, 1161, 1162, 1163, 1164, 1165, 1166, 1167, 1168, 1169, 1170, 1171, 1172, 1173, 1174, 1175, 1176, 1177, 1178, 1179, 1180, 1181, 1182, 1183, 1184, 1185, 1186, 1187, 1188, 1189, 1190, 1191, 1192, 1193, 1194, 1195, 1196, 1197, 1198, 1199, 1200, 1201, 1202, 1203, 1204, 1205, 1206, 1207, 1208, 1209, 1210, 1211, 1212, 1213, 1214, 1215, 1216, 1217, 1218, 1219, 1220, 1221, 1222, 1223, 1224, 1225, 1226, 1227, 1228, 1229, 1230, 1231, 1232, 1233, 1234, 1235, 1236, 1237, 1238, 1239, 1240, 1241, 1242, 1243, 1244, 1245, 1246, 1247, 1248, 1249, 1250, 1251, 1252, 1253, 1254, 1255, 1256, 1257, 1258, 1259, 1260, 1261, 1262, 1263, 1264, 1265, 1266, 1267, 1268, 1269, 1270, 1271, 1272, 1273, 1274, 1275, 1276, 1277, 1278, 1279, 1280, 1281, 1282, 1283, 1284, 1285, 1286, 1287, 1288, 1289, 1290, 1291, 1292, 1293, 1294, 1295, 1296, 1297, 1298, 1299, 1300, 1301, 1302, 1303, 1304, 1305, 1306, 1307, 1308, 1309, 1310, 1311, 1312, 1313, 1314, 1315, 1316, 1317, 1318, 1319, 1320, 1321, 1322, 1323, 1324, 1325, 1326, 1327, 1328, 1329, 1330, 1331, 1332, 1333, 1334, 1335, 1336, 1337, 1338, 1339, 1340, 1341, 1342, 1343, 1344, 1345, 1346, 1347, 1348, 1349, 1350, 1351, 1352, 1353, 1354, 1355, 1356, 1357, 1358, 1359, 1360, 1361, 1362, 1363, 1364, 1365, 1366, 1367, 1368, 1369, 1370, 1371, 1372, 1373, 1374, 1375, 1376, 1377, 1378, 1379, 1380, 1381, 1382, 1383, 1384, 1385, 1386, 1387, 1388, 1389, 1390, 1391, 1392, 1393, 1394, 1395, 1396, 1397, 1398, 1399, 1400, 1401, 1402, 1403, 1404, 1405, 1406, 1407, 1408, 1409, 1410, 1411, 1412, 1413, 1414, 1415, 1416, 1417, 1418, 1419, 1420, 1421, 1422, 1423, 1424, 1425, 1426, 1427, 1428, 1429, 1430, 1431, 1432, 1433, 1434, 1435, 1436, 1437, 1438, 1439, 1440, 1441, 1442, 1443, 1444, 1445, 1446, 1447, 1448, 1449, 1450, 1451, 1452, 1453, 1454, 1455, 1456, 1457, 1458, 1459, 1460, 1461, 1462, 1463, 1464, 1465, 1466, 1467, 1468, 1469, 1470, 1471, 1472, 1473, 1474, 1475, 1476, 1477, 1478, 1479, 1480, 1481, 1482, 1483, 1484, 1485, 1486, 1487, 1488, 1489, 1490, 1491, 1492, 1493, 1494, 1495, 1496, 1497, 1498, 1499, 1500, 1500, 1501, 1502, 1503, 1504, 1505, 1506, 1507, 1508, 1509, 1510, 1511, 1512, 1513, 1514, 1515, 1516, 1517, 1518, 1519, 1520, 1521, 1522, 1523, 1524, 1525, 1526, 1527, 1528, 1529, 1530, 1531, 1532, 1533, 1534, 1535, 1536, 1537, 1538, 1539, 1540, 1541, 1542, 1543, 1544, 1545, 1546, 1547, 1548, 1549, 1550, 1551, 1552, 1553, 1554, 1555, 1556, 1557, 1558, 1559, 1560, 1561, 1562, 1563, 1564, 1565, 1566, 1567, 1568, 1569, 1570, 1571, 1572, 1573, 1574, 1575, 1576, 1577, 1578, 1579, 1580, 1581, 1582, 1583, 1584, 1585, 1586, 1587, 1588, 1589, 1590, 1591, 1592, 1593, 1594, 1595, 1596, 1597, 1598, 1599, 1600, 1601, 1602, 1603, 1604, 1605, 1606, 1607, 1608, 1609, 1610, 1611, 1612, 1613, 1614, 1615, 1616, 1617, 1618, 1619, 1620, 1621, 1622, 1623, 1624, 1625, 1626, 1627, 1628, 1629, 1630, 1631, 1632, 1633, 1634, 1635, 1636, 1637, 1638, 1639, 1640, 1641, 1642, 1643, 1644, 1645, 1646, 1647, 1648, 1649, 1650, 1651, 1652, 1653, 1654, 1655, 1656, 1657, 1658, 1659, 1660, 1661, 1662, 1663, 1664, 1665, 1666, 1667, 1668, 1669, 1670, 1671, 1672, 1673, 1674, 1675, 1676, 1677, 1678, 1679, 1680, 1681, 1682, 1683, 1684, 1685, 1686, 1687, 1688, 1689, 1690, 1691, 1692, 1693, 1694, 1695, 1696, 1697, 1698, 1699, 1700, 1701, 1702, 1703, 1704, 1705, 1706, 1707, 1708, 1709, 1710, 1711, 1712, 1713, 1714, 1715, 1716, 1717, 1718, 1719, 1720, 1721, 1722, 1723, 1724, 1725, 1726, 1727, 1728, 1729, 1730, 1731, 1732, 1733, 1734, 1735, 1736, 1737, 1738, 1739, 1740, 1741, 1742, 1743, 1744, 1745, 1746, 1747, 1748, 1749, 1750, 1751, 1752, 1753, 1754, 1755, 1756, 1757, 1758, 1759, 1760, 1761, 1762, 1763, 1764, 1765, 1766, 1767, 1768, 1769, 1770, 1771, 1772, 1773, 1774, 1775, 1776, 1777, 1778, 1779, 1780, 1781, 1782, 1783, 1784, 1785, 1786, 1787, 1788, 1789, 1790, 1791, 1792, 1793, 1794, 1795, 1796, 1797, 1798, 1799, 1800, 1801, 1802, 1803, 1804, 1805, 1806, 1807, 1808, 1809, 1810, 1811, 1812, 1813, 1814, 1815, 1816, 1817, 1818, 1819, 1820, 1821, 1822, 1823, 1824, 1825, 1826, 1827, 1828, 1829, 1830, 1831, 1832, 1833, 1834, 1835, 1836, 1837, 1838, 1839, 1840, 1841, 1842, 1843, 1844, 1845, 1846, 1847, 1848, 1849, 1850, 1851, 1852, 1853, 1854, 1855, 1856, 1857, 1858, 1859, 1860, 1861, 1862, 1863, 1864, 1865, 1866, 1867, 1868, 1869, 1870, 1871, 1872, 1873, 1874, 1875, 1876, 1877, 1878, 1879, 1880, 1881, 1882, 1883, 1884, 1885, 1886, 1887, 1888, 1889, 1890, 1891, 1892, 1893, 1894, 1895, 1896, 1897, 1898, 1899, 1900, 1901, 1902, 1903, 1904, 1905, 1906, 1907, 1908, 1909, 1910, 1911, 1912, 1913, 1914, 1915, 1916, 1917, 1918, 1919, 1920, 1921, 1922, 1923, 1924, 1925, 1926, 1927, 1928, 1929, 1930, 1931, 1932, 1933, 1934, 1935, 1936, 1937, 1938, 1939, 1940, 1941, 1942, 1943, 1944, 1945, 1946, 1947, 1948, 1949, 1950, 1951, 1952, 1953, 1954, 1955, 1956, 1957, 1958, 1959, 1960, 1961, 1962, 1963, 1964, 1965, 1966, 1967, 1968, 1969, 1970, 1971, 1972, 1973, 1974, 1975, 1976, 1977, 1978, 1979, 1980, 1981, 1982, 1983, 1984, 1985, 1986, 1987, 1988, 1989, 1990, 1991, 1992, 1993, 1994, 1995, 1996, 1997, 1998, 1999, 2000, 2001, 2002, 2003, 2004, 2005, 2006, 2007, 2008, 2009, 2010, 2011, 2012, 2013, 2014, 2015, 2016, 2017, 2018, 2019, 2020, 2021, 2022, 2023, 2024, 2025, 2026, 2027, 2028, 2029, 2030, 2031, 2032, 2033, 2034, 2035, 2036, 2037, 2038, 2039, 2040, 2041, 2042, 2043, 2044, 2045, 2046, 2047, 2048, 2049, 2050, 2051, 2052, 2053, 2054, 2055, 2056, 2057, 2058, 2059, 2060, 2061, 2062, 2063, 2064, 2065, 2066, 2067, 2068, 2069, 2070, 2071, 2072, 2073, 2074, 2075, 2076, 2077, 2078, 2079, 2080, 2081, 2082, 2083, 2084, 2085, 2086, 2087, 2088, 2089, 2090, 2091, 2092, 2093, 2094, 2095, 2096, 2097, 2098, 2099, 2100, 2101, 2102, 2103, 2104, 2105, 2106, 2107, 2108, 2109, 2110, 2111, 2112, 2113, 2114, 2115, 2116, 2117, 2118, 2119, 2120, 2121, 2122, 2123, 2124, 2125, 2126, 2127, 2128, 2129, 2130, 2131, 2132, 2133, 2134, 2135, 2136, 2137, 2138, 2139, 2140, 2141, 2142, 2143, 2144, 2145, 2146, 2147, 2148, 2149, 2150, 2151, 2152, 2153, 2154, 2155, 2156, 2157, 2158, 2159, 2160, 2161, 2162, 2163, 2164, 2165, 2166, 2167, 2168, 2169, 2170, 2171, 2172, 2173, 2174, 2175, 2176, 2177, 2178, 2179, 2180, 2181, 2182, 2183, 2184, 2185, 2186, 2187, 2188, 2189, 2190, 2191, 2192, 2193, 2194, 2195, 2196, 2197, 2198, 2199, 2200, 2201, 2202, 2203, 2204, 2205, 2206, 2207, 2208, 2209, 2210, 2211, 2212, 2213, 2214, 2215, 2216, 2217, 2218, 2219, 2220, 2221, 2222, 2223, 2224, 2225, 2226, 2227, 2228, 2229, 2230, 2231, 2232, 2233, 2234, 2235, 2236, 2237, 2238, 2239, 2240, 2241, 2242, 2243, 2244, 2245, 2246, 2247, 2248, 2249, 2250, 2251, 2252, 2253, 2254, 2255, 2256, 2257, 2258, 2259, 2260, 2261, 2262, 2263, 2264, 2265, 2266, 2267, 2268, 2269, 2270, 2271, 2272, 2273, 2274, 2275, 2276, 2277, 2278, 2279, 2280, 2281, 2282, 2283, 2284, 2285, 2286, 2287, 2288, 2289, 2290, 2291, 2292, 2293, 2294, 2295, 2296, 2297, 2298, 2299, 2300, 2301, 2302, 2303, 2304, 2305, 2306, 2307, 2308, 2309, 2310, 2311, 2312, 2313, 2314, 2315, 2316, 2317, 2318, 2319, 2320, 2321, 2322, 2323, 2324, 2325, 2326, 2327, 2328, 2329, 2330, 2331, 2332, 2333, 2334, 2335, 2336, 2337, 2338, 2339, 2340, 2341, 2342, 2343, 2344, 2345, 2346, 2347, 2348, 2349, 2350, 2351, 2352, 2353, 2354, 2355, 2356, 2357, 2358, 2359, 2360, 2361, 2362, 2363, 2364, 2365, 2366, 2367, 2368, 2369, 2370, 2371, 2372, 2373, 2374, 2375, 2376, 2377, 2378, 2379, 2380, 2381, 2382, 2383, 2384, 2385, 2386, 2387, 2388, 2389, 2390, 2391, 2392, 2393, 2394, 2395, 2396, 2397, 2398, 2399, 2400, 2401, 2402, 2403, 2404, 2405, 2406, 2407, 2408, 2409, 2410, 2411, 2412, 2413, 2414, 2415, 2416, 2417, 2418, 2419, 2420, 2421, 2422, 2423, 2424, 2425, 2426, 2427, 2428, 2429, 2430, 2431, 2432, 2433, 2434, 2435, 2436, 2437, 2438, 2439, 2440, 2441, 2442, 2443, 2444, 2445, 2446, 2447, 2448, 2449, 2450, 2451, 2452, 2453, 2454, 2455, 2456, 2457, 2458, 2459, 2460, 2461, 2462, 2463, 2464, 2465, 2466, 2467, 2468, 2469, 2470, 2471, 2472, 2473, 2474, 2475, 2476, 2477, 2478, 2479, 2480, 2481, 2482, 2483, 2484, 2485, 2486, 2487, 2488, 2489, 2490, 2491, 2492, 2493, 2494, 2495, 2496, 2497, 2498, 2499, 2500. etc., and any combination thereof.

In some aspects, the techniques described herein relate to the sheet that may have elasticity, wherein 100% elasticity is a fivefold increase, and no increase in size is 0%.

In some aspects, the techniques described herein relate to the sheet, neck, base, and/or vertical/perpendicular opening may have elasticity of 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100%, and/or any combination thereof.

In some aspects, the techniques described herein relate to the sheet that may be made of textile.

In some aspects, the techniques described herein relate to the sheet that may be made of one selected from a group comprising of plant natural fibers (such as cotton, flax, linen), animals natural fibers (such as wool, silk), minerals natural fibers (for example, asbestos), synthetic fibers, polyester, nylon, petrochemicals nylon, petrochemicals acrylic, polyacrylonitrile-acrylic polyester from polyethylene terephthalate, recycled plastic, etc., and/or any combination thereof.

In some aspects, the techniques described herein relate to the sheet being coated with waterproof materials selected from a group comprising polyurethane (PU), polyvinyl chloride (PVC), polytetrafluoroethylene (PTFE), etc., and/or any combination thereof. This coating layer/s may form a barrier that prevents water from penetrating the sheet/textile while allowing vapor/air to escape in some cases, making the material breathable.

In some aspects, the techniques described herein relate to the sheet that may be made of fabrics that may be made with highly tight weaves, like ripstop nylon, which help reduce the spaces between fibers, making it harder for water to pass through. Combined with or without waterproof coatings, this creates a robust barrier.

In some aspects, the techniques described herein relate to the sheet that may be coated with durable water-resistant/repellent materials selected from a group comprising a Fluoropolymer-based DWR (PFCs), Perfluorocarbons (PFCs), fluorocarbons, silicone, wax, Polyurethane, Graphene, Cationic Hydrophobic Polymer, etc., and/or any combination thereof.

In some aspects, the techniques described herein relate to the sheet that may have a durable water-repellent coating, and the treated sheet surface may be the fabric, causing water to bead up and roll off the surface instead of being absorbed. This treatment may need to be reapplied when it wears off. Furthermore, the sheet may be made of hydrophobic fibers, such as polyester and nylon, naturally resisting water absorption. Combined with the water-resistant/repellent coating, they become more effective at repelling moisture.

In some aspects, the techniques described herein relate to the cavity may be configured to contain at least one item protected from paint and other outer environmental elements, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, items., or any combination thereof.

In some aspects, the techniques described herein relate to the item that may be any house-hold materials such as outdoor furniture, appliances, lighting, fixtures, fans, decorative materials, sofas, chairs, beds, tables, desks, wardrobes, bookshelves, dressers, nightstands, ottomans, TV stands, larger storage solutions, cabinets, benches, bar stools, large appliances, refrigerators, washing machines, dryers, ovens, microwaves, dishwashers, air conditioners, heaters, water heaters, small appliances such as toasters, blenders, coffee makers, electric kettles, food processors, slow cookers, vacuum cleaners, irons, hair dryers, fans, storage solutions, storage bins, closet organizers, shoe racks, pantry shelving, under-bed storage, coat racks, and laundry baskets, lighting, fixtures, table lamps, floor lamps, ceiling fans with lights, chandeliers, wall sconces, pendant lights, household electronics, televisions, speakers, gaming consoles, computers, routers, smart home devices, and alarm clocks, kitchenware, cutlery, cookware, utensils, dishware, glassware, cutting boards, mixing bowls, soft furnishings, rugs, curtains, cushions, pillows, blankets, upholstery, curtains, bedding, rugs, carpets, bedding, bathroom-equipped, shower curtains, bath mats, toothbrush holders, soap dispensers, towel racks, and mirrors, outdoor furniture, patio chairs, outdoor tables, hammocks, garden umbrellas, indoor or outdoor plants, garden plants, fences, decorative items, wall art, picture frames, vases, decorative mirrors, candles, planters, sculptures, walls, ceiling, doors, flooring, windows, countertops, marble etc., and/or any combination thereof.

In some aspects, the techniques described herein relate to the item that may be made of any natural material, artificial material, wood, oak, pine, maple, plywood, MDF, medium-density fiberboard, glass, tempered glass, frosted glass, laminated glass, fabric, textiles, cotton, linen, polyester, silk, wool, velvet, metal stainless steel, aluminum, iron, brass, plastic, polypropylene, acrylic, PVC, ceramic, porcelain, ceramic tiles porcelain tiles, stone, granite, slate, rubber, paper, cardboard, leather, foam, concrete, adhesives glue, epoxy, caulk, tape, cork, and/or any combination thereof.

In some aspects, the techniques described herein relate to the cavity and may be waterproof, water-resistant, air-tight, near air-tight, chemical-resistant, chemical-proof, breathable, anti-microbial, or any combination thereof.

In some aspects, the techniques described herein relate to the apparatus may be reusable and/or disposable. The apparatus or parts thereof may be reused up to 1,000 times, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 2010, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000, etc., and any combination thereof.

In some aspects, the techniques described herein relate to the apparatus, a part such as a neck, base, perpendicular/vertical opening, sheet, and/or sheet, and/or entire apparatus may be made by cutting, sewing, gluing, fabric gluing, iron-on taping, hem taping, bonding tape, fixing, webbing, safety pining, fabric clipping, velcro striping, hook-and-loop fasteners, stapling, snapping buttons or pressing studs, patching, molding, three-dimensional printing, etc., and/or any combination thereof.

In some aspects, the apparatus may include internal pockets or support structures designed to hold or stabilize specific items within the cavity. For example, a mesh pocket may secure a remote control on an enclosed appliance, or internal frame elements may maintain the shape of the apparatus around a ceiling fan or tall furniture. These features prevent shifting during use and help maintain consistent coverage.

### DETAILED DESCRIPTION OF THE FIGURES

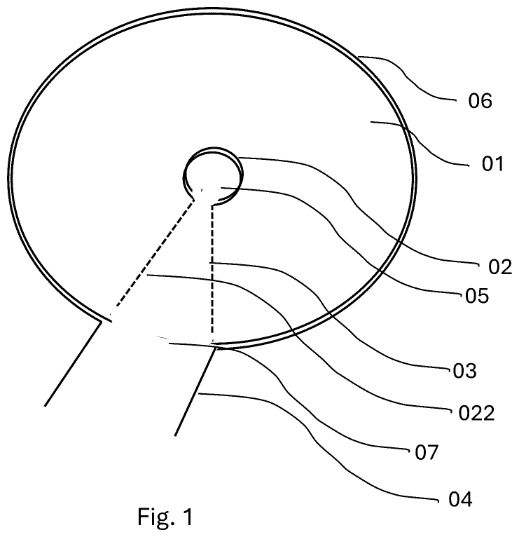

FIG. 1. Top view of flattened apparatus. The view shows a circular neck [05] that is rubber-lined or coated [02]. The neck may also have a neck-attachment system (not shown) that may attach the apparatus to the items within or objects outside to form an air-tight or near-air-tight seal (some liquids and/or gases may pass through) to protect the item within from paint, chemicals, water, and other damaging environmental elements and/or any combination thereof. The neck may further contain an elastic system that may assist the neck opening in closing and protecting the items within from paint, chemicals, water, other environmental elements, etc., and/or any combination thereof. The base opening [07] may have a base attachment and/or elastic systems on the sheet's [01] edge [06]. Both these systems may assist in closing the base opening to protect the item from paint, water, chemicals, other environmental elements, etc., or any combination thereof. Shown herein is a drawstring system [04] around the edge [06] that is part of the elastic system and is used to close the base opening [07]. The two openings, neck and base, are linked or joined together by a perpendicular/vertical opening [03, 022]. The perpendicular/vertical opening has two sides, left [022] and right [03], forming a perpendicular/vertical-opening attachment system. The apparatus is made of a sheet [01].

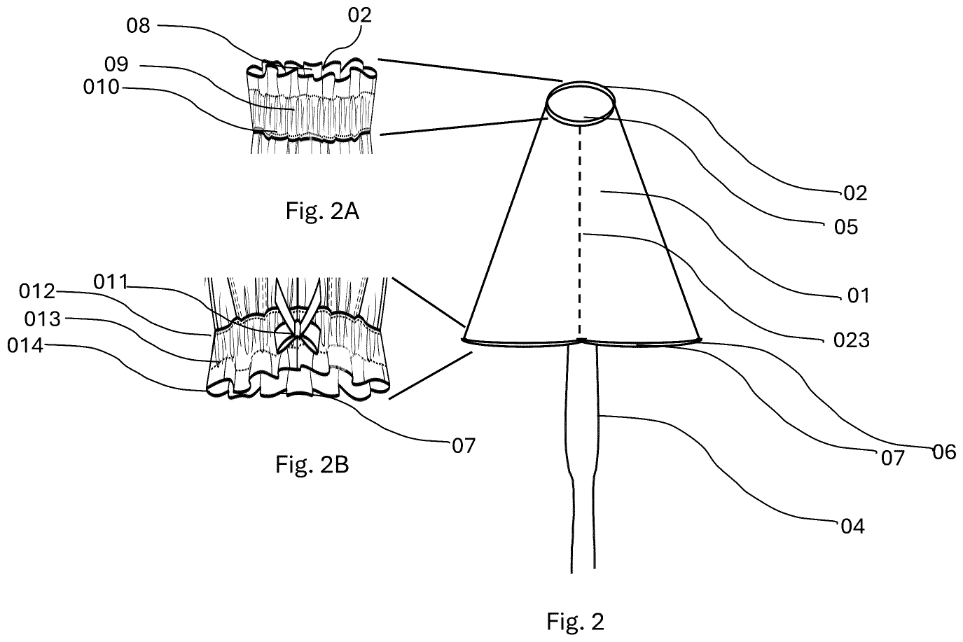

FIG. 2. Side view of the apparatus. The view shows an apparatus made of a sheet [01] and a circular neck [02] that is made of rubber, rubber-lined, and/or coated [02] to form a conical or triangular-shaped apparatus. The base [07, 06] may have a base attachment and/or elastic systems on the edge [06]. Shown herein is a drawstring system [04] around the edge [06] that is part of the elastic system and is used to close the opening. The neck and base openings are linked or joined by a perpendicular/vertical opening [03/022]. The neck may have an attachment system; for example, on the top of the pleats, any outer, inner, top, and/or bottom surface, the attachment system may be localized such that the neck may attach the neck to the outer objects, items within, and/or to itself to for a air-tight or near air-tight seal. The neck opening is [05], the base opening is [07], and the perpendicular/vertical opening is [023].

FIG. 2A. The neck features are further shown in detail. The neck-elastic system [08, 09, 010] in this example is made of elastic material and rubber [09], which forms pleats or ruffles [08]. The elastic system may have another layer of elastic materials, drawstring, belt, etc., [010]. Multiple elastic layers may be possible, for example 1, 2, 3, 4, 5, 6, 7, 8, 9, 10, 11, 12, 13, 14, 15, 16, 17, 18, 19, 20, etc. In addition to the multiple elastic layers, multiple layers of attachment system may be present, for example 1, 2, 3, 4, 5, 6, 7, 8, 9, 10, 11, 12, 13, 14, 15, 16, 17, 18, 19, 20, etc.

FIG. 2B. The base features are shown in detail. The base-elastic and base-attachment systems [011, 012, 013, 014]. This example is made of drawstring material [011] and elastic [012], and/or rubber [013], which forms pleats or ruffles [0114]. The elastic system may have at least one layer of elastic materials [012 and/or 013], drawstring, belt, [011], etc. Multiple elastic layers may be possible, for example 1, 2, 3, 4, 5, 6, 7, 8, 9, 10, 11, 12, 13, 14, 15, 16, 17, 18, 19, 20, etc. In addition, multiple layers of attachment system may be present, for example, 1, 2, 3, 4, 5, 6, 7, 8, 9, 10, 11, 12, 13, 14, 15, 16, 17, 18, 19, 20, etc. Both these systems may be localized on the inner, outer, upper, and/or bottom of the base and/or part of the base-opening [07].

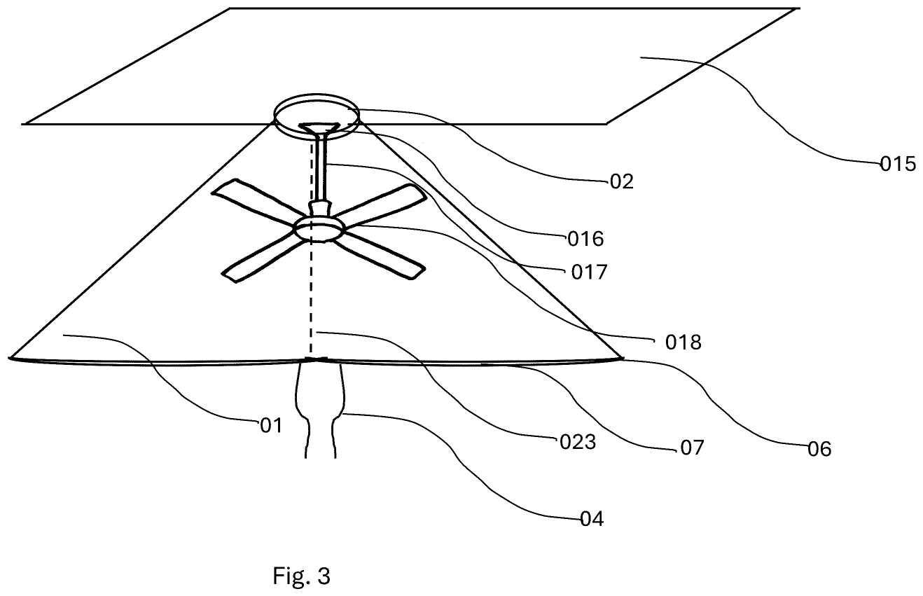

FIG. 3. Side view of the apparatus with a ceiling fan inside without base closing [07]. The view shows a circular neck [02] that is closed and sealed around the ceiling fan [016, 017, 18] base-plate [016] and/or fan rod [017] attached to the ceiling [015]. The sealing may be with the fan rod [016], fan base-plate [016] and/or ceiling [015]. The base [07, 06] may have a base attachment and/or elastic systems on the edge [06] and/or any other part of the sheet [01], which is open but may be closed as a final step. Shown herein is a drawstring system [04] around the edge [06] that is part of the elastic system and is used to close the base-opening. The neck and base openings are linked or joined by a perpendicular/vertical opening [023] in the closed state.

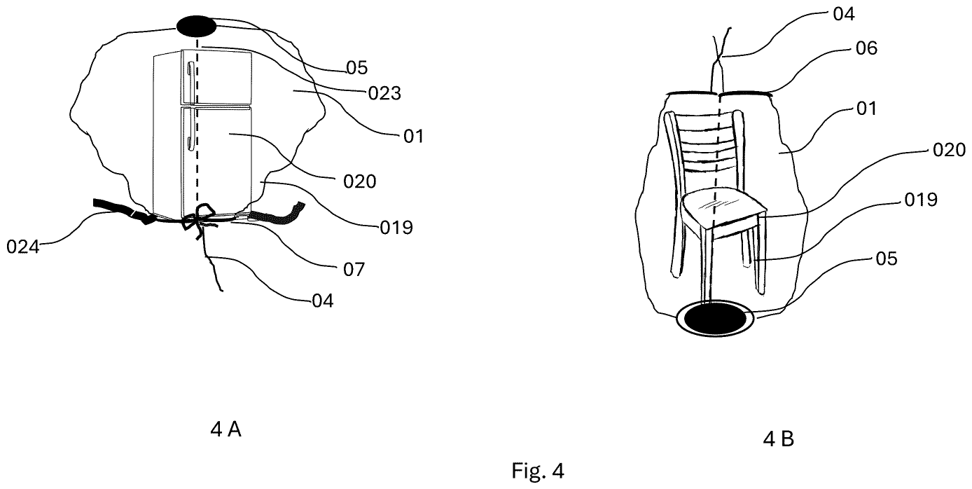

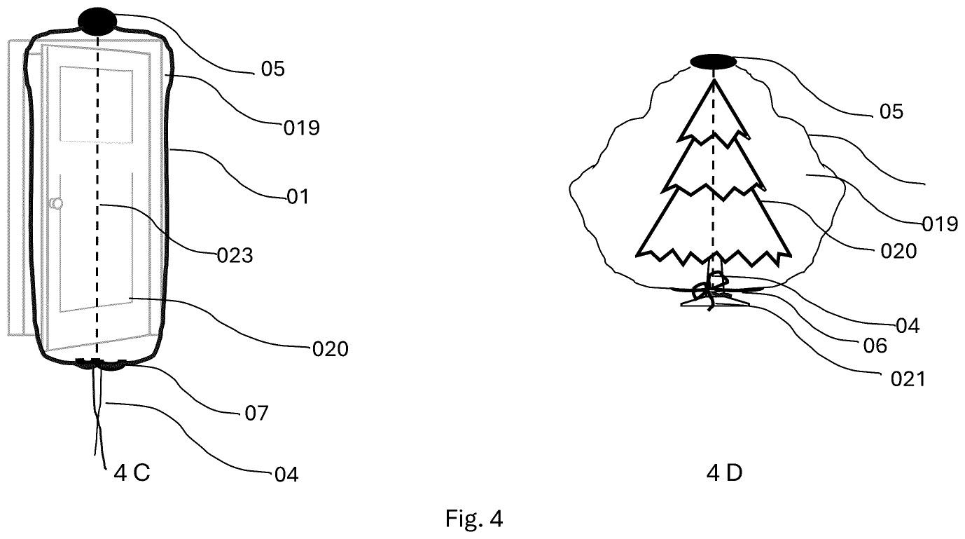

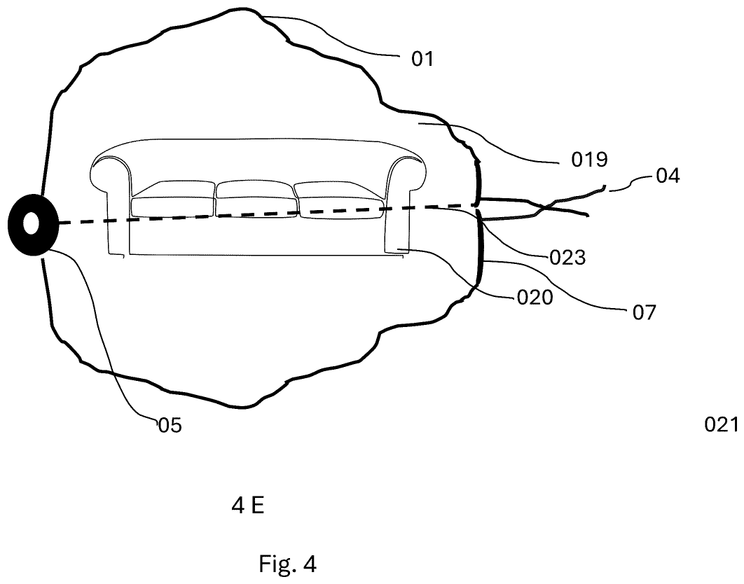

FIG. 4. Views of the apparatus with items within the apparatus cavity. FIGS. 4A through 4E illustrate the use of the apparatus to enclose various objects within the defined cavity of the protective cover. These figures demonstrate the adaptability of the apparatus to different shapes and sizes. Shown herein are examples of items [019] that can be placed and protected within the apparatus cavity [19] formed by sheet [01], base opening [07], neck [05], and perpendicular vertical opening [023].

FIG. 4A. View of the apparatus with a refrigerator within or enclosed within the apparatus cavity. This view shows the protection of a large appliance (refrigerator). The refrigerator may not be moved from the floor [024], and the base opening is tried around the item with a drawstring [04]. The cavity conforms to the appliance's structure, and the base and neck openings are adjusted to provide a snug fit.

FIG. 4B. View of the apparatus showing a chair within the apparatus cavity. A chair is an example of furniture that may be completely enclosed within the apparatus cavity [019]. The apparatus described herein is used upside down, unlike other examples herein. The base is at the top of the chair, and the neck opening is at the bottom of the chair. The flexible sheet wraps around the contours of the chair while the perpendicular opening is partially secured using drawstrings and fasteners.

FIG. 4C. View of the apparatus with a door within the apparatus cavity. The apparatus may protect items attached to the walls and allow the wall to be painted. In this example, a door [020] is enclosed within the apparatus's cavity [019] to protect the door from paint. The apparatus is suspended to fully enclose the door from top to bottom, with the base drawn tightly around the lower edge using the elastic system.

FIG. 4D. View of the apparatus with a tree within the apparatus cavity. The apparatus may protect outdoor items, such as a tree or shrub [020]. The base opening may be tied around the tree trunk at the tree's bottom area [021]. This example illustrates the apparatus enclosing a small tree. The elastic base opening expands to accommodate the width of the tree's foliage and trunk, and the neck opening is secured near the base of the pot.

FIG. 4E. View of the apparatus with a sofa within the apparatus cavity. In this example, a large piece of furniture is protected, and the apparatus is used sideways, making the perpendicular opening parallel to the large side of the sofa. Depicts the apparatus fully enclosing a sofa. The flexible sheet drapes over the furniture while the openings are tightened and sealed to protect the structure from paint, dust, and debris.

It is to be understood that the above description is intended to be illustrative and not restrictive. For example, the above-described embodiments (and/or aspects thereof) may be used in combination with each other. In addition, many modifications may be made to adapt a particular situation, method, system device, or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. The embodiments described herein are exemplary and not limiting; variations, modifications, and equivalents that would be apparent to those skilled in the art are intended to fall within the scope of this disclosure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claim.

1. A paint cover apparatus comprising: a sheet configured to define a cavity; three openings, wherein the three openings comprise: a first opening configured to form a neck; a second opening configured to form a base; and a third opening extending between the first opening and the second opening, the third opening being oriented perpendicular to the first and second openings; wherein the first and second openings are substantially parallel to each other; wherein the third opening is configured to connect the first and second openings; and wherein the cavity defined by the sheet is flexible and paint-resistant.

2. The paint cover apparatus of claim 1, wherein the apparatus is reusable.

3. The paint cover apparatus of claim 1, wherein the apparatus comprises at least one attachment system.

4. The paint cover apparatus of claim 1, wherein the apparatus comprises at least one elastic system.

5. The paint cover apparatus of claim 1, wherein the neck has a size ranging from 6 inches to 75 inches when open.

6. The paint cover apparatus of claim 1, wherein the neck has a size ranging from 0.0 to 71.0 inches when closed.

7. The paint cover apparatus of claim 1, wherein the neck is rubberized, wherein the neck is rubberized, and the rubberized portion comprises one or more materials selected from the group consisting of high-density spunbound polyethylene fibers, Spunbond Polypropylene, silicone, neoprene, polyurethane, ethylene propylene diene monomer, nitrile rubber, polyvinyl chloride, thermoplastic elastomers, natural rubber latex, thermoplastic polyester elastomer, butyl rubber, cork, fluoroelastomer, styrene-butadiene rubber, graphene-enhanced materials, natural rubber, man-made rubber, polymer, flex seal, and any combination thereof.

8. The paint cover apparatus of claim 1, wherein the neck comprises one or more materials selected from the group consisting of high-density spunbound polyethylene fibers, Spunbond Polypropylene, Melt blown Polypropylene, Polyethylene-Coated Fabrics, Polyvinyl Chloride Coated Fabrics, Woven High-Density Polyethylene Fabrics, High-Density Polyethylene Geomembranes, waxed fabric or paper, Mylar, biaxially-oriented polyethylene terephthalate, Polyester Film, Non-Woven Cellulose Materials, Vellum, Yupo synthetic paper, Gore-Tex, expanded polytetrafluoroethylene, Polylactic Acid Non-Woven Fabrics, Eco-Non-Woven Fabrics made from natural fibers like jute or hemp, PE or PVC-Coated Tarpaulins, and any combination thereof.

9. The paint cover apparatus of claim 1, wherein the base comprises at least one elastic system, wherein the elastic system is at least one drawstring, wherein the at least one drawstring is located at the base.

10. The paint cover apparatus of claim 9, wherein the at least one drawstring comprises one or more materials selected from the group consisting of cotton, nylon, polyester, leather, Paracord, jute, hemp, Elastic Cords, Polypropylene, silk, satin, blended fibers, natural and synthetic fibers, and any combination thereof.

11. The paint cover apparatus of claim 1, wherein the base has a size range from 6 inches to 75 inches when the apparatus is in its open state.

12. The paint cover apparatus of claim 1, wherein the base has a size ranging from 0 to 70 inches when the apparatus is in its closed state.

13. The apparatus of claim 1, wherein the sheet is circular and has a diameter of up to 2500 inches.

14. The paint cover apparatus of claim 1, wherein the third opening comprises two sides, a left side and a right side, wherein one or both sides comprise an attachment system, and wherein the attachment system is detachably attached.

15. The paint cover apparatus of claim 14, wherein the attachment system comprises one or more components selected from the group consisting of a zipper, hook-and-loop fasteners, Velcro, buttons, snaps and buttons, buttons-holes, stapling, pinning, riveting, snaps, fabric snaps, binding, taping, safety-pins, hand-basting stitches, machine-basting stitches, stapling, magnets, stapling magnets, magnetic fasteners, fabric tape, removal tape, adhesive tapes, glue, adhesives, double-sides taps, mechanical fasteners, plastic clamps, hook and eye, suction cups, and any combination thereof.

16. The paint cover apparatus of claim 1, wherein the third perpendicular opening size ranges from 1 inch to 1200 inches.

17. The paint cover apparatus of claim 1, wherein the sheet comprises a textile selected from the group consisting of plant natural fibers, cotton, flax, linen, animals natural fibers, wool, silk, minerals natural fibers, asbestos, synthetic fibers, polyester, nylon, petrochemicals nylon, petrochemicals acrylic, polyacrylonitrile-acrylic polyester from polyethylene terephthalate, recycled plastic, and any combination thereof.

18. The paint cover apparatus of claim 1, wherein the sheet is coated with a waterproof material selected from the group consisting of polyurethane, polyvinyl chloride, polytetrafluoroethylene, and any combination thereof.

19. The paint cover apparatus of claim 1, wherein the sheet is coated with water-resistant materials selected from a group consisting of durable water-repellent coating, hydrophobic fibers, synthetic fibers, polyester, nylon, and other materials that are naturally resistant to water absorption, and any combination thereof.

20. The paint cover apparatus of claim 1, configured to contain at least one item and protect the at least one item from chemicals, water, moisture, and environmental temperature fluctuations.
